(19) United States
(12) Patent Application Publication
(10) Pub. No.: US 2012/0046907 A1
(43) Pub. Date: Feb. 23, 2012

(54) TRAINING AID

(76) Inventor: Travis Scott, Kansas City, MO (US)

(21) Appl. No.: 13/216,036

(22) Filed: Aug. 23, 2011

Related U.S. Application Data
(60) Provisional application No. 61/376,096, filed on Aug. 23, 2010.

(51) Int. Cl. G06F 15/00

(52) U.S. Cl. 702/151

(57) ABSTRACT

A training method and apparatus for improving a physical technique, action, move or routine includes a portable electronic device which may be unobtrusively worn by the user. The portable electronic device includes motion sensor such as an accelerometer and/or gyroscope to determine the orientation and movement of the device. By monitoring the output of the motion sensor and applying the values according to predetermined movements, the user may be immediately provided positive and negative feedback. The device may be worn by the user during exercise or a sporting event without interfering with the user's movement.

### CROSS-REFERENCE TO RELATED APPLICATION

This application claims the benefit of co-pending application Ser. No. 61/376,096, filed on Aug. 23, 2010, entitled TRAINING AID.

### FIELD

The present invention relates to training aids and, more particularly, to an electronic training aid for physical activity which provides concurrent feedback to the user.

### BACKGROUND

Training aids for physical activities such as sports or exercise routines are known in the art. Some of these aids force the user to repetitively follow a particular motion to learn the proper technique. These aids often require normal equipment apart from the training aid equipment used to guide or restrict the user during training. Other training aids are used in place of the normal equipment, such as a baseball bat or golf club. While these aids may be beneficial while practicing, they cannot be used when participating in the activity. Additionally, some training aids are not physically practical and may not be allowed when participating in the activity, resulting in a disconnect between the training session and the session for which the training is directed, such as a round of golf. Further, the training aids are often just that—training aids. They are specialized devices or pieces of equipment that are not particularly useful for anything else. Once a practice or training session is complete, the training equipment or aid must be set aside or stored until used again for training.

Other training aids require expensive equipment such as video cameras, video manipulation, interpretation and analysis, software and specialized equipment. One such system is a golf swing analyzer utilizing a high speed video recording system. The user is videoed from one or more angles while swinging a golf club. A golf professional or coach may observe a user while recording a series of golf swings. The user and golf professional may then view the recorded video to identify problems, poor techniques and areas for improvement. While this system is useful and effective while in the training studio with the instructor, it provides no feedback to the user in the native environment of the exercise routine or sport. Further, these training aids are costly, require technical expertise to use and require scheduling and planning.

### SUMMARY

The present invention provides a training method and apparatus for improving a physical technique, action, move or routine. The training method and apparatus includes a portable electronic device which may be unobtrusively worn by the user. The portable electronic device includes a motion sensor such as an accelerometer and/or gyroscope to determine the orientation and movement of the device. By monitoring the output of the motion sensor and applying the values according to predetermined movements, the user may be immediately provided positive and negative feedback pertaining to the proper physical technique, action, move or routine. The device may be worn by the user during exercise or a sporting event without interfering with the user's movement.

### BRIEF DESCRIPTION OF THE DRAWINGS

FIG. 1 illustrates a coordinate system for a portable electronic device.

FIG. 2 illustrates angular readings for various orientations of the electronic devices of FIG. 1 in the X-Y plane.

FIG. 3 illustrates the angular readings for various orientation of the electronic device of FIG. 1 in the X-Z plane.

FIG. 4 illustrates the angular readings for various orientations of the electronic device of FIG. 1 in the Y-Z plane.

FIG. 5 illustrates the electronic device positioned to measuring a putting movement.

FIG. 6 illustrates the electronic device positioned to measure a stroke movement.

FIG. 7 illustrates the electronic device positioned to measure a head movement.

FIG. 8 illustrates the electronic device positioned to measure hip movement.

FIG. 9 is a flow chart illustrating the initial function selection.

FIG. 10 is a flow chart illustrating the putting motion algorithm.

FIG. 11 is a flow chart illustrating the shoulder turn/rotation algorithm.

FIG. 12 is a flow chart illustrating the head motion algorithm.

FIG. 13 is a flow chart illustration the hip turn algorithm.

FIG. 14 is a flow chart illustrating an initial exercise algorithm.

FIG. 15 is a flow chart illustrating the sit-ups algorithm.

### DETAILED DESCRIPTION

As required, detailed embodiments of the present invention are disclosed herein. However, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Moreover, except where otherwise expressly indicated, all numerical quantities in this description and in the claims are to be understood as modified by the word “about” in describing the broader scope of this invention. Practice within the numerical limits stated is generally preferred. Also, unless expressly stated to the contrary, the description of a group or class of materials as suitable or preferred for a given purpose in connection with the invention implies that mixtures or combinations of any two or more members of the group or class may be equally suitable or preferred.

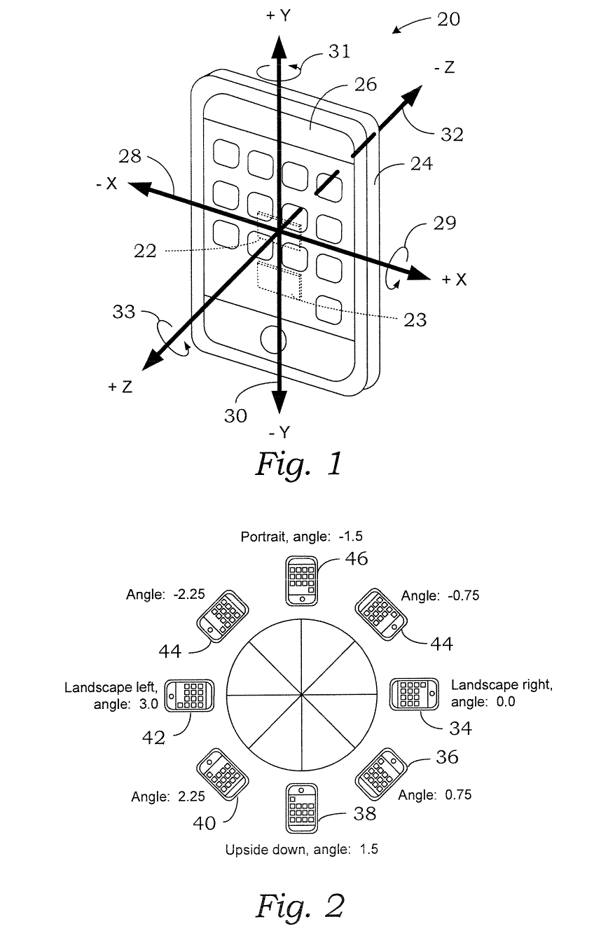

Referring initially to FIGS. 1-4, a training aid is generally indicated by reference numeral 20. Training aid 20 is a portable, electronic device which includes one or more motion sensors such as a three-axis accelerometer 22 such as a LIS302DL MEMS (micromechanical system) motion sensor available from STMicroelectronics NV, and/or a gyroscope 23 such as a L3GD20 MEMS gyroscope also available from STMicroelectronics, for example. The LIS302DL is an ultra-compact, low-power, three-axis linear accelerometer which is integrated in portable electronic devices such as the iPhone and iPod Touch available from Apple Inc. for example. Other portable electronic devices utilizing the LIS302DL accelerometer, or utilizing another accelerometer may be used with the training aid 20. The LIS302DL accelerometer operates in a range of +/−2 g in the iPhone and iPod Touch with a nominal resolution of 0.018 g. The L3GD20 gyroscope offers a wide set of user-programmable full-scale ranges from ±250 dps (degrees per second) up to ±2000 dps, with the low full-scale values for high accuracy of slow-motion sensing and the high range to detect and measure very fast gestures and movements. The device provides a 16-bit data output, together with additional embedded digital features, such as configurable low- and high-pass filters.

The training aid 20 includes a case 24 and a touch screen 26. For illustration purposes only, the training aid 20 will be described with a touch screen 26. However, it should be understood that devices utilizing other displays, input and selection configurations, such as a key pad, may be used.

The training aid 20 includes three axes of orientation—the X-axis 28, Y-axis 30 and Z-axis 32. The X-axis 28 is an imaginary line running laterally through the center of the accelerometer 22. As illustrated, the accelerometer 22 is mounted behind the touch screen 26 within the case 24 at the center of the training aid 20. The X-axis 28 is perpendicular to the Y-axis 30 and Z-axis 32 in a horizontal plane parallel to the touch screen 26 running through the left and right sides of the training aid 20 case 24. The Y-axis 30 is an imaginary line running vertically through the center of the accelerometer 22. The Y-axis 30 is perpendicular to the X-axis 28 and Z-axis 32 in a vertical plane parallel to the touch screen 26 running through the top and bottom sides of the training aid 20 case 24. The Z-axis 32 is an imaginary line running perpendicularly through the center of the accelerometer 22. The Z-axis 32 is perpendicular to the X-axis 28 and Y-axis 30 in a horizontal plane running perpendicularly through the touch screen 26 and back of the case 24.

As the training aid 20 is moved or rotated, the accelerometer 22 outputs three values, one for each axis. For example, the X-value output of the accelerometer as the training aid is rotated in the X-Y plane is illustrated in FIG. 2. When the training aid 20 is in a landscape right orientation 34, the X-output from the accelerometer 22 is 0.0. As the training aid 20 is rotated clockwise, the X-output from the accelerometer 22 increases. At an orientation of 45° 36 from the landscape right orientation 34, the X-output of the accelerometer 22 is 0.75. At an orientation of 90° 38 from the landscape right orientation 34 the X-output of the accelerometer 22 is 1.5. At an orientation of 135° 40 from the landscape right orientation 34, the X-output of the accelerometer 22 is 2.25. At an orientation of 180° 42 from the landscape right orientation 34, the X-output of the accelerometer 22 is 3.0. Rotating the opposite way at an orientation of −45° 44 from the landscape right orientation 34, the X-output of the accelerometer is −0.75. At an orientation of −90° 46 from the landscape right orientation 34 the X-output of the accelerometer 22 is −1.5. At an orientation of 135° 48 from the landscape right orientation 34, the X-output of the accelerometer 22 is −2.25. The outputs shown in FIGS. 2-4 are scaled examples not the raw output from the accelerometer 22. The specific output from the accelerometer 22 is a function of the particular device and is available from the manufacturer and technical specifications.

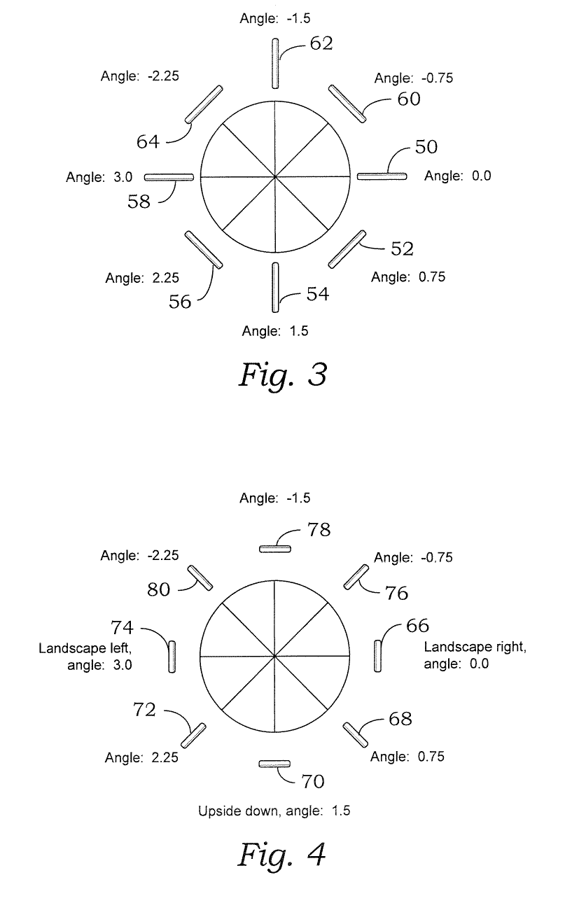

As the training aid 20 is rotated in the Y-Z plane, the Y-value output of the accelerometer is illustrated in FIG. 3. When the training aid 20 is in a landscape right face-up orientation 50, the Y-output from the accelerometer is 0.0. As the training aid 20 is rotated clockwise in the Y-Z plane, the Y-output from the accelerometer 22 increases. At an orientation of 45° 52 from the landscape right face-up orientation 50, the Y-output of the accelerometer 22 is 0.75. At an orientation of 90° 54 from the landscape right face-up orientation 50, the Y-output of the accelerometer 22 is 1.5. At an orientation of 135° 56 from the landscape right face-up orientation 50, the Y-output of the accelerometer 22 is 2.25. At an orientation of 180° 58 from the landscape right face-up orientation 50, the Y-output of the accelerometer 22 is 3.0. Rotating the training aid 20 in the opposite direction at an orientation of −45° 60 from the landscape right face-up orientation 50, the Y-output of the accelerometer 22 is −0.75. At an orientation of −90° 62 from the landscape right face-up orientation 50, the Y-output of the accelerometer 22 is −1.5. At an orientation of −135° 64 from the landscape right face-up orientation 50, the Y-output of the accelerometer 22 is −2.25.

As the training aid 20 is rotated in the X-Z plane, the Z-value output of the accelerometer is illustrated in FIG. 4. When the training aid is in a landscape right face-left orientation 66, the Z-output of the accelerometer 22 is 0.0. At an orientation of 45° 68 from the landscape right face-left orientation 66, the Z-output of the accelerometer 22 is 0.75. At an orientation of 90° 70 from the landscape right face-left orientation 66, the Z-output of the accelerometer 22 is 1.5. At an orientation of 135° 72 from the landscape right face-left orientation 66, the Z-output of the accelerometer 22 is 2.25. At an orientation of 180° 74 from the landscape right face-left orientation 66, the Z-output of the accelerometer 22 is 30. Rotating the opposite way, at an orientation of −45° 76 from the landscape right face-left orientation 66, the Z-output of the accelerometer 22 is −0.75. At an orientation of −90° 78 from the landscape right face-left orientation 66, the Z-output of the accelerometer 22 is −1.5. At an orientation of −135° 80 from the landscape right face-left orientation 66, the Z-output of the accelerometer 22 is −2.25.

The gyroscope 23 outputs 8- or 16-bit data at a rate of ±250 dps to ±2000 dps in each axis corresponding to pitch 29, roll 31 and yaw 33. From the raw data, the angular rate or velocity of the training aid 20 may be determined.

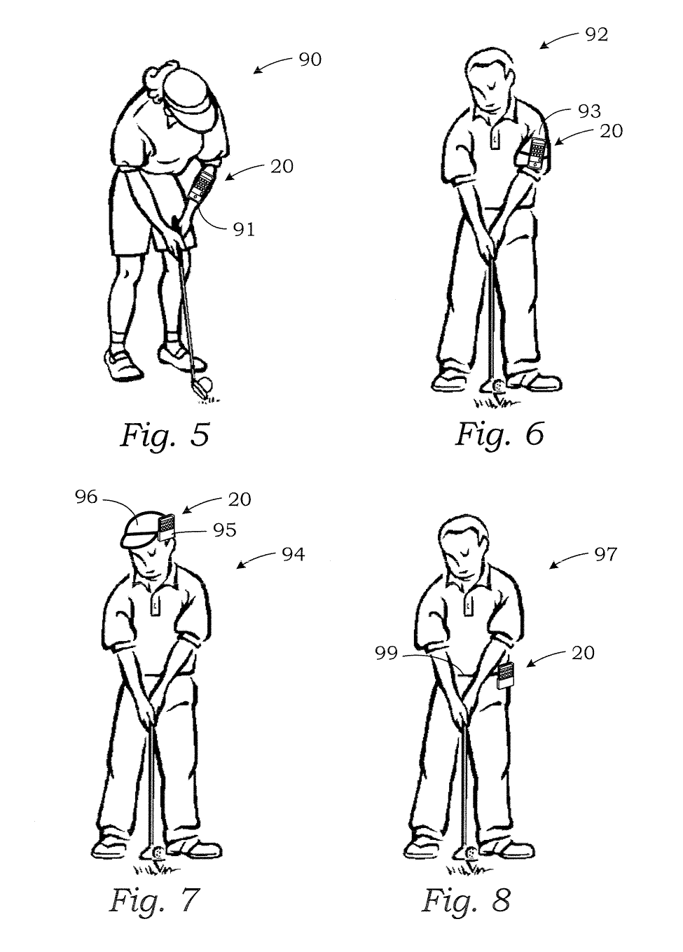

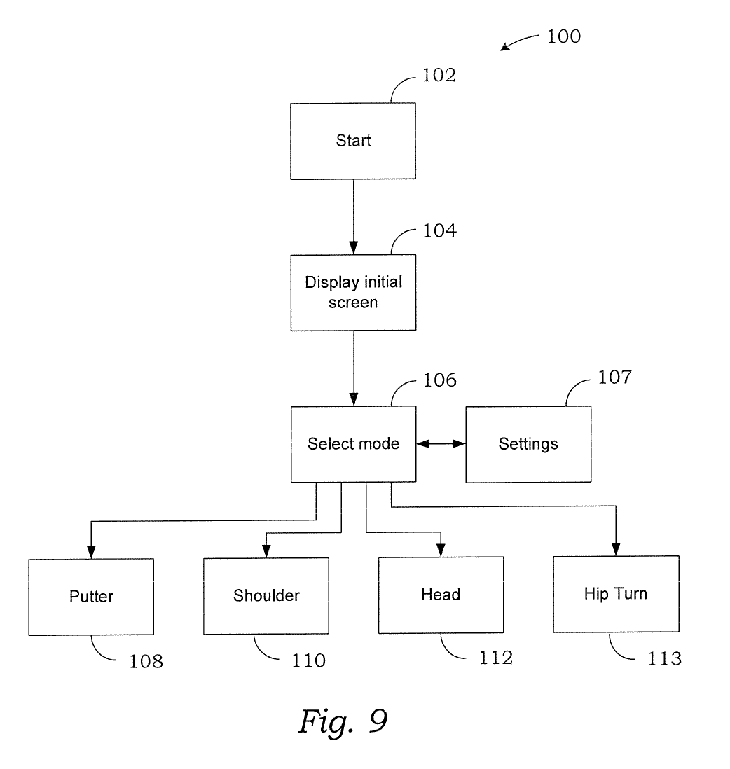

Referring to FIGS. 5-9, use of the training aid 20 is disclosed herein by reference to movements related to golf as an example and for illustrative purposes only. The training aid 20 is not limited to detecting and providing feedback for golf movements only. One of ordinary skill in the art will readily recognize other applications for the present invention which are within the scope of this disclosure, such as exercise routines, baseball, tennis, dance, basketball, bowling, or any physical activity that includes repetitious moves for the activity or in practice or training.

A user initially selects the training aid application 100 loaded on the training aid 20. The training aid 20 includes a microprocessor or computer and computer-readable media such as RAM. The training aid application 100 includes computer-executable instructions on the computer-readable media for interpretation by the microprocessor or computer. When the training aid application 100 is executed by the microprocessor, the training aid 20 provides instructions to the user by way of the display or touch screen 26, and feedback to the user by way of an audio or tactile output.

When the training aid application 100 is initially selected by the user, the microprocessor begins execution of the application 102, and an initial screen is displayed 104. For purposes of providing a disclosure of the present invention, an exemplary application is described, but is not so limited. The exemplary application is related to a training aid application for golf. For this example application, the user is presented a choice of three modes of operation 106. The user may select a putting motion mode 108, a shoulder turn/rotation mode 110, a head motion mode 112, and a hip turn mode 113.

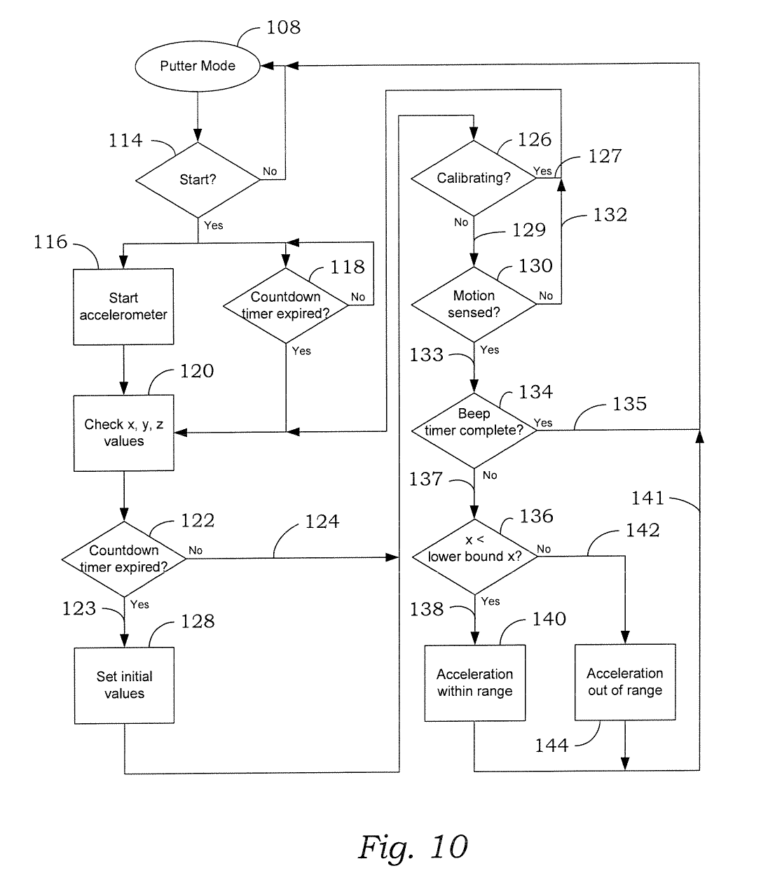

Referring to FIGS. 5 and 10, if the putting motion mode 108 is selected, the user 90 places the training aid 20 on his or her forearm 91 by way of a strap or other means to secure the training aid 20 to his or her forearm 91. Once the training aid 20 is positioned on his or her forearm 91, the user 90 taps the touch screen 26 to start the putting motion mode 114. At this point the accelerometer 22 is started 116 and a countdown timer is started 118. The countdown timer gives the user 90 time to get his or her hands and arms in position to practice a putting motion. While the countdown timer is running 118, the X, Y and Z values output from the accelerometer 22 are collected 120. If the countdown timer has not expired 122, processing continues 124 to block 126 where it is determined if the X, Y and Z values have been stabilized, if they have not stabilized the system continues to calibrate 127 and reads another set of X, Y and Z values 120. The X, Y and Z values are read approximately 50 times per second.

Once the countdown timer expires 123, the initial X, Y and Z values are set 128. The values are checked to determine if they are stable 126. If the values are not stable, the process continues to calibrate 127 and reads another set of values 120, which are then set 128. Once calibration is completed 129, a motion sensor 130 monitors movement of the training aid 20. As long as the motion is not sensed 132, another set of values is read 120 and stored 128.

Once motion is sensed 133, a check is made to determine if a beep timer has completed 134. The beep timer gives the user time to complete his or her putting motion within a predetermined period of time. If the beep timer has expired 135, then the training aid 20 outputs a negative indication in the form of an audio or tactile negative feedback and processing returns to the beginning 108.

If the beep timer is not complete 137, the X value is compared to a lower bound X value 136. If the X value is less than the lower bound X value 138, then the measured acceleration was within the proper range 140. If the X value is greater than the lower bound X value 142, then the measured acceleration was not within the proper range 144. This lower bound comparison may be use for right-handed putting.

For left-handed putting, the X value is compared to an upper bound X value. If the X value is greater than the upper bound X value, then the measured acceleration was within the proper range. If the X value is lower than the upper bound X value, then the measured acceleration was not within the proper range.

If the X value is within the proper acceleration range 140, then the user 90 accelerated through the putt within an acceptable range of X values, and the training aid 20 outputs a positive indication in the form of an audio or tactile positive feedback. If the X value is not within the proper range 144, then the user 90 did not accelerate through the putt within an acceptable range of X values and the training aid 20 outputs a negative indication in the form of an audio or tactile negative feedback. Processing then returns to the beginning of the putting motion mode 108.

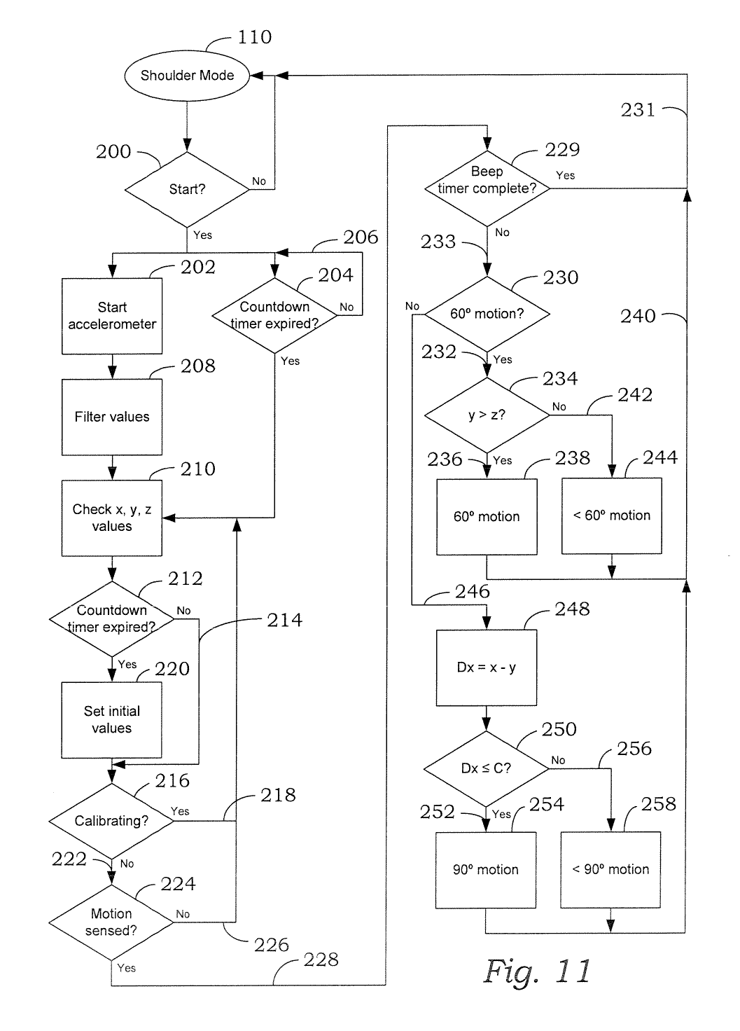

Referring to FIGS. 6 and 11, if the shoulder turn/rotation mode 110 is selected, the user 92 places the training aid 20 on his or her upper arm 93 or shoulder by way of a strap or other means to secure the training aid 20 to his or her shoulder. Once the training aid 20 is positioned on his or her upper arm or shoulder 93, the user 92 taps the touch screen 26 to start the shoulder turn/rotation mode 200. The accelerometer 202 and countdown timer 204 are started. While the countdown timer 204 has not expired 206, the output of the accelerometer is filtered 208. The output of the filter is as follows:

X=Accel X*filter constant+X*(1.0−filter constant)

Y=Accel Y*filter constant+Y*(1.0−filter constant)

Z=Accel Z*filter constant+Z*(1.0−filter constant)

### Where:

Accel X, Accel Y and Accel Z are the X, Y, Z values output by the accelerometer 22.

Filter const=dt/(dt+RC)

dt=1.0/50.0

RC=1/5

The filter 208 smoothes the values output by the accelerometer 22. The new X, Y and Z values from the filter 208 are read 210. If the countdown timer 204 has not expired 212, processing continues 214 to block 216 where it is determined if the X, Y and Z values have stabilized. If the X, Y and Z values have not stabilized, the system continues to calibrate 216 and returns 218 to read another set of X, Y and Z values 210.

The countdown timer 204 is checked 212, and if it has expired 213, the initial X, Y and Z values are set 220. If the values are not stable, the process continues to calibrate 218 and reads another set of values 210, which are then set 220. Once calibration is completed 222, a motion sensor 224 monitors movement of the training aid 20. As long as the motion is not sensed 226, another set of values is read 210 and stored 220.

Once motion is sensed 228, a beep timer is checked 229. The beep timer gives the user time to complete his or her shoulder turn motion within a predetermined period of time. If the beep timer has expired 231, then the training aid 20 outputs a negative indication in the form of an audio or tactile negative feedback and processing returns to the beginning 110.

If the beep timer is not complete 233, a check is made to determine if the user previously selected a 60° motion or a 90° motion 230. If the user selected a 60° motion 232, the Y value is compared to the Z value 234. If the Y value is greater than the Z value 236, then a 60° turn has been measured 238 and the user 92 is given an audio or tactile positive feedback and processing returns 240 to the beginning 110. It should be understood that the 60° turn or a 90° turn are approximate values and may be set to a range or to other values as desired such as approximately 45° for example.

If the Y value is less than or equal to the Z value 242, then at least a 60° turn has not been measured 244 and the user 92 is given an audio or tactile negative feedback. Processing then returns 240 to the beginning 110.

If the user selected a 90° motion 246, the change in the value X is calculated as Dx=X−Y 248. Dx is then compared to a constant 250. If Dx is less than or equal to the constant 252, then a 90° turn has been measured 254 and the user 92 is given an audio or tactile positive feedback. Processing returns 240 to the beginning 110.

If Dx is greater than a constant 256, then at least a 90° turn has not been measured 258 and the user 92 is given an audio or tactile negative feed back. Processing then returns 240 to the beginning 110.

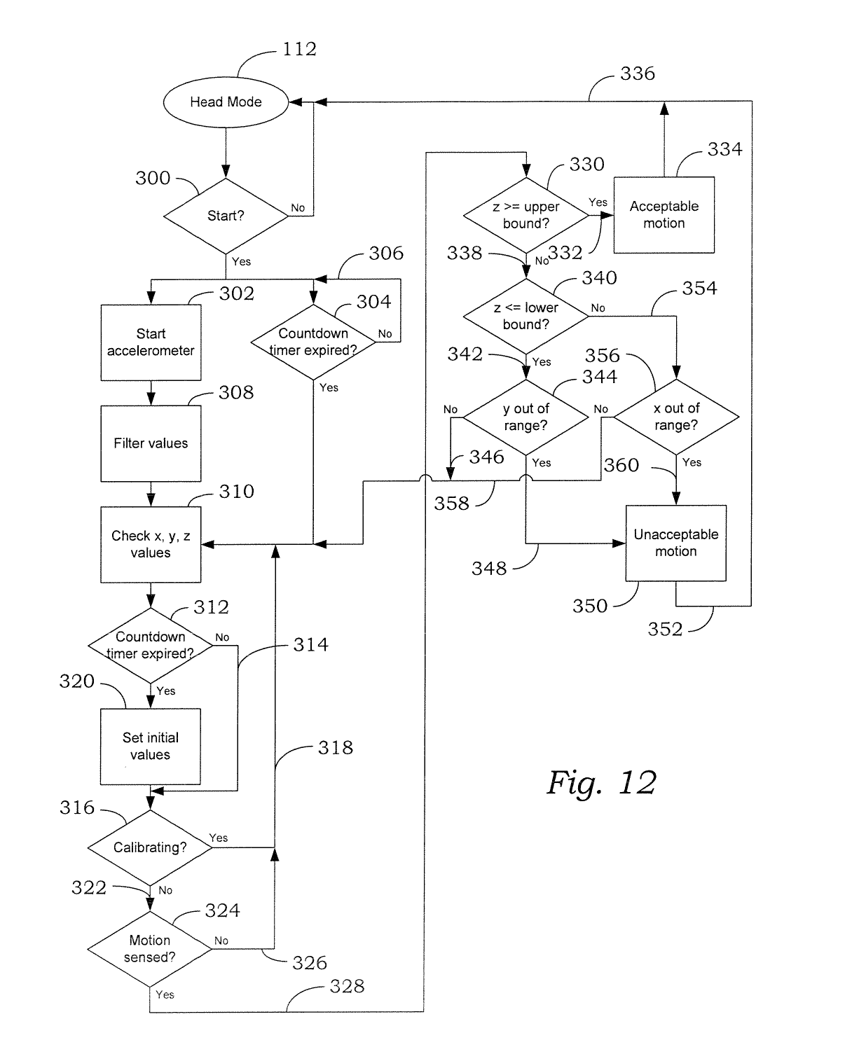

Referring to FIGS. 7 and 12, if the head motion mode 112 is selected, the user 94 places the training aid 20 on the side of his or her head by way of a strap, pocket 95 on his or her cap 96 or other means to secure the training aid 20 to the side of his or her head. Once the training aid 20 is positioned on the side of his or her head, the user 94 taps the touch screen 26 to start the head motion mode 300. The accelerometer 302 and countdown timer 304 are started. While the countdown timer 304 has not expired 306, the output of the accelerometer is filtered 308. The output of the filter 308 is as follows:

X=Accel X*filter constant+X*(1.0−filter constant)

Y=Accel Y*filter constant+Y*(1.0−filter constant)

Z=Accel Z*filter constant+Z*(1.0−filter constant)

### Where:

Accel X, Accel Y and Accel Z are the X, Y, Z values output by the accelerometer 22.

Filter const=dt/(dt+RC)

dt=1.0/50.0

RC=1/5

The filter 308 smoothes the values output by the accelerometer 22. The new X, Y and Z values from the filter 308 are read 310. If the countdown timer 304 has not expired 312, processing continues 314 to block 316 where it is determined if the X, Y and Z values have stabilized. If the X, Y and Z values have not stabilized, the system continues to calibrate 316 and returns 318 to read another set of X, Y and Z values 310. Once calibration is completed 322, a motion sensor 324 monitors movement of the training aid 20. As long as the motion is not sensed 326, another set of values is read and stored 310.

Once the motion timer expires 328, the Z value is compared to the upper bound 330. If the Z value is greater than or equal to the upper bound 332, then the user's head motion is acceptable. The user 94 is given an audio or tactile positive feedback 334 and processing returns 336 to the beginning 112.

If the Z value is not greater than the upper bound 338, it is checked against a lower bound 340. If the Z value is less than or equal to the lower bound 342 then the Y value is checked to determine if it is out of range 344. If the Y value is not out of range 346, then processing returns to block 310. If the Y value is out of range 348, then the user's head motion is not accepted 350 and the training aid 20 outputs a negative feedback to the user 94 in the form of an audio or tactile signal. Processing then returns 352 to the beginning 112.

If the Z value is not less than the lower bound 354, then the X value is checked to determine if it is out of range 356. If the X value is not out of range 358, then processing returns to block 310. If the X value is out of range 360, then the user's head motion is not accepted 350 and the training aid outputs a negative feedback to the user 94 in the form of an audio or tactile signal. Processing then returns 352 to the beginning 112.

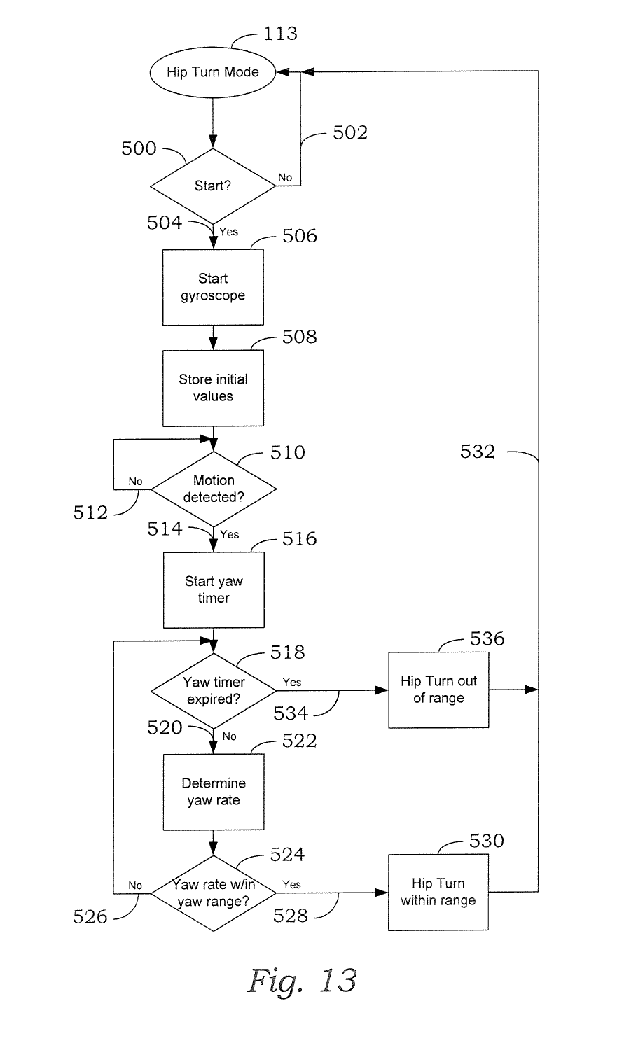

Referring to FIGS. 8 and 13, if the hip turn/rotation mode 113 is selected, the user 97 places the training aid 20 on his or her waist 99 by way of a belt or other means to secure the training aid 20 to his or her waist 99. The system checks for a start signal 500. If no start signal is received, 502, the system continues to wait. Once the training aid 20 is positioned, the user 97 taps the touch screen 26 to start the hip turn/rotation mode 504. The gyroscope is started 506 and the initial gyroscope values, pitch 29, roll 31, and yaw 33 are stored 508.

Output from the gyroscope 23 is monitored to detect motion indicating that the user 97 has begun his or her swing 510. If no motion is detected 512, the system continues to wait. Once motion is detected 514, a yaw rate timer is started 516. Expiration of the yaw rate timer is checked 518. If the yaw rate timer has not expired 520, then the yaw value is calculated 522 based on the yaw output 33 of the gyroscope 23. The yaw value is compared to a range 524. If the yaw value is not greater than a predetermined yaw range 526, then processing returns to block 518. If the yaw value is greater than the predetermined yaw range 528, then a proper hip turn has been accomplished 530, the training aid 20 outputs a positive indication in the form of an audio or tactile positive feedback and processing returns 532 to the beginning 113.

If the yaw timer expires 534, then a proper hip turn has not been accomplished 536. The training aid 20 outputs a negative indication in the form of an audio or tactile negative feedback and processing returns 532 to the beginning 113.

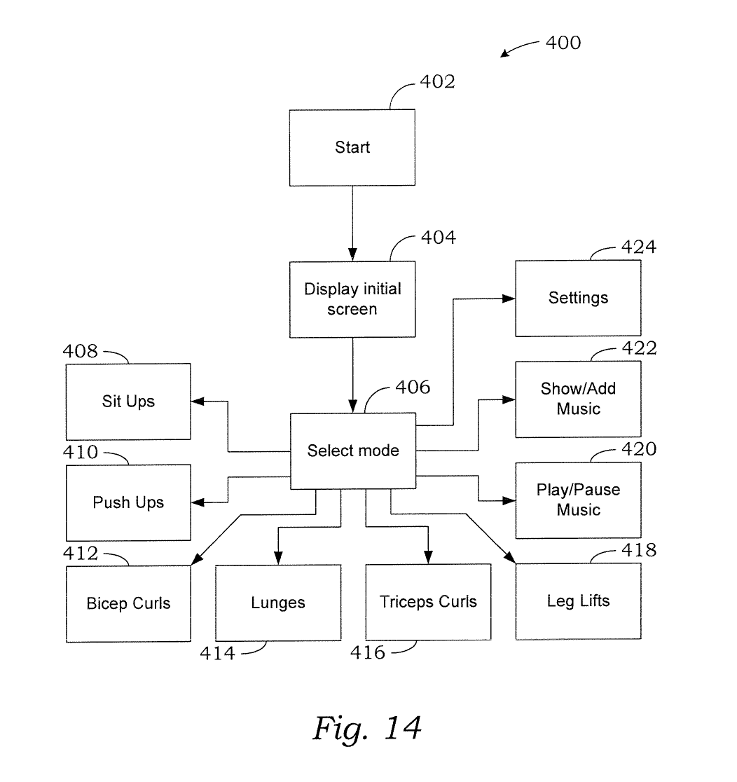

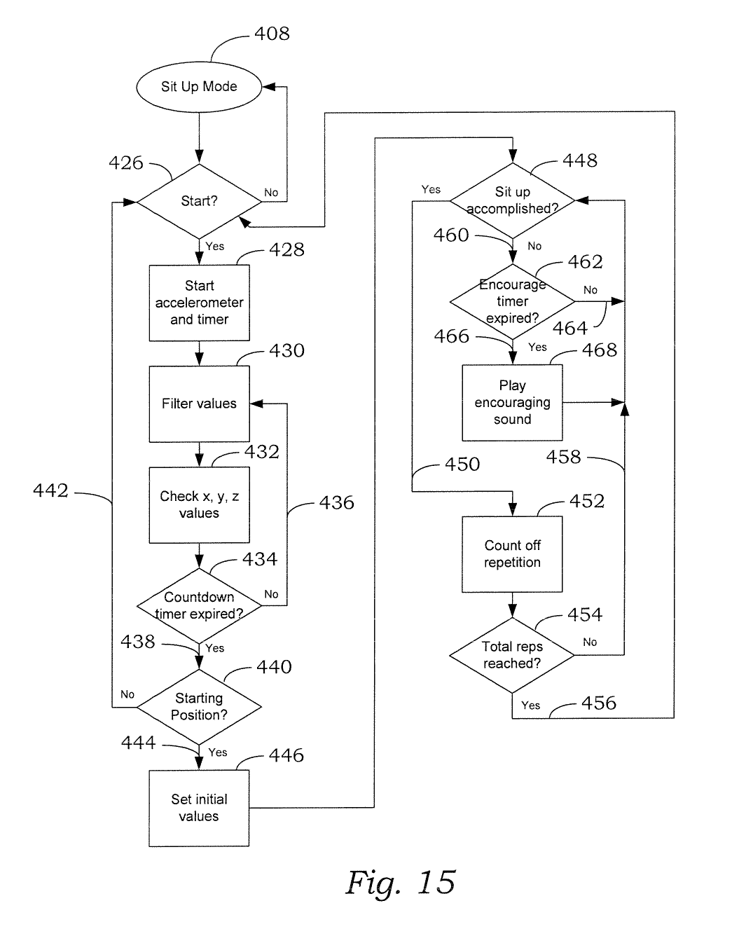

Referring to FIGS. 14 and 15, use of the training aid 20 is disclosed herein by reference to movements related to a sit-up exercise as an example and for illustrative purposes only. The training aid 20 is not limited to detecting and providing feedback for sit-up exercises movements only. One of ordinary skill in the art will readily recognize other applications for the present invention which are within the scope of this disclosure.

Referring to FIG. 14, a flow chart for selection of an exercise training movement is generally indicated by reference numeral 400. The exercise training mode is selected 402 and an initial screen is displayed 404. The user is presented with a number of options to select 406, including a sit-up exercise mode 408, a push-ups exercise mode 410, a bicep curls exercise mode 412, a lunges exercise mode 414, a triceps curls exercise mode 416, and leg lifts exercise mode 418. Other functions such as play/pause music 420, show/add music 422 and a settings mode 424 may also be displayed for selection. In the settings mode 424, options may be entered or selected for the number of sit-ups, the time to complete the selected number of sit-ups, a time interval for each sit-up, a countdown timer, and music to play while exercising, for example.

Referring to FIGS. 1 and 15, if the sit-up mode 408 is selected, the training aid 20 is secured to the middle of the user's upper arm or chest and the user taps the touch screen 26 to start the sit-ups mode 426. At this point the accelerometer 22 and countdown timer are started 428. The output of the accelerometer is filtered 430. The output of the filter is as follows:

X=Accel X*filter constant+X*(1.0−filter constant)

Y=Accel Y*filter constant+Y*(1.0−filter constant)

Z=Accel Z*filter constant+Z*(1.0−filter constant)

### Where:

Accel X, Accel Y and Accel Z are the X, Y, Z values output by the accelerometer 22.

Filter const=dt/(dt+RC)

dt=1.0/50.0

RC=1/5

The filter 430 smoothes the values output by the accelerometer 22. The new X, Y and Z values from the filter 430 are read 432. If the countdown timer 434 has not expired 436, processing returns to block 432 to read another set of X, Y and Z values.

If the countdown timer 434 has expired 438, the initial X, Y and Z values are checked to determine if the values are stable and indicate a valid starting position 440. If the values are not stable or are not indicative of a valid sit-up starting position 442, such as lying on one's back, then processing returns to the start 426. If a valid starting position is detected 444, then the initial values are set 446. The processor monitors the X, Y and Z values to determine if a sit-up is accomplished 448. If a sit-up has been accomplished 450, the repetition count is incremented 452, and compared to the total repetitions 454. If the total repetition count has been reached 456, then the exercise session ends and returns to the start 426. If the total repetition count has not been reached, 458, then processing returns for the next sit-up 448. If a sit-up has not been accomplished 460, the sit-up encouragement timer is checked 462. If the sit-up encouragement timer has not expired 464 then processing returns to determine if the sit-up has been completed 448. If the sit-up timer has expired 466, then an encouragement sound 468 may be played to encourage the user to keep going or try harder, for example.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is as follows:

1. A training apparatus worn by a user comprising:
a portable electronic device having a microprocessor, a motion sensor, a user input, a display and an output,
said motion sensor having a predetermined X-axis, Y-axis and Z-axis orientation, and responsive to movement of said portable electronic device to output X-axis, Y-axis and Z-axis values, and
a mode of operation executed by said microprocessor wherein said microprocessor is responsive to said motion sensor output to provide feedback to the user corresponding to said movement.

2. The training apparatus of claim 1 wherein said mode of operation is selected by the user utilizing said user input.

3. The training apparatus of claim 1 wherein said mode of operation includes a putter mode for measuring a golf putting motion and providing feedback to the user, wherein said microprocessor calculates acceleration of the portable electronic device from said X-axis value output by said motion sensor, if said measured X-axis value is greater than a lower boundary X value then said microprocessor activates said audio output to indicate a proper putting motion, if said measured X-axis value is less than a lower boundary X value, said microprocessor activates said output to indicate an improper putting motion.

4. The training apparatus of claim 3 wherein said portable electronic device is secured to the user's forearm.

5. The training apparatus of claim 1 wherein said mode of operation includes a shoulder mode for measuring a golf club swing motion and providing feedback to the user, wherein said microprocessor calculates acceleration of the portable electronic device from said X-axis, Y-axis and Z-axis values to measure a swing motion of the user's shoulders, if said Y-axis value is greater than said Z-axis value, then a sixty degree turn has been measured then said microprocessor activates said output to indicate a proper swing motion, if said Y-axis value is less than or equal to said Z-axis value, then less than a sixty degree turn has been measured, and said microprocessor activates said output to indicate an improper swing motion.

6. The training apparatus of claim 5 wherein said portable electronic device is secured to the user's shoulder.

7. The training apparatus of claim 1 wherein said mode of operation includes a shoulder mode for measuring a golf club swing motion and providing feedback to the user, wherein said microprocessor calculates acceleration of the portable electronic device from said X-axis, Y-axis and Z-axis values to measure a swing motion of the user's shoulders, if the difference of said X-axis minus said Y-axis value is less than or equal to a constant then a ninety degree turn has been measured then said microprocessor activates said output to indicate a proper swing motion, if the difference of said X-axis minus said Y-axis value is less greater than a constant then less than a ninety degree turn has been measured then said microprocessor activates said output to indicate an improper swing motion.

8. The training apparatus of claim 7 wherein said portable electronic device is secured to the user's shoulder.

9. The training apparatus of claim 1 wherein said mode of operation includes a head motion mode for measuring the user's head motion during a swing motion and providing feedback to the user, wherein said microprocessor calculates acceleration of the portable electronic device from said X-axis, Y-axis and Z-axis values to measure a swing motion of the user's head, if said Y-axis value is greater than said Z-axis value, then a sixty degree turn has been measured then said microprocessor activates said output to indicate a proper swing motion, if said Y-axis value is less than or equal to said Z-axis value, then less than a sixty degree turn has been measured, and said microprocessor activates said output to indicate an improper swing motion.

10. The training apparatus of claim 9 wherein said portable electronic device is secured to the user's head.

11. The training apparatus of claim 1 wherein said mode of operation includes a hip turn mode for measuring the user's hip turn during a swing motion and providing feedback to the user, wherein said microprocessor calculates angular rotation rate of the portable electronic device from said X-axis, Y-axis and Z-axis values to determine a yaw value to measure a hip turn motion of the user's hips, if said yaw value is greater than a predetermined yaw range value measured within a predetermined yaw time period, then a proper hip turn been measured and said microprocessor activates said output to indicate a proper hip turn motion, if said yaw value is less than or equal to said predetermined yaw range value and said predetermined yaw time period has expired, then said microprocessor activates said output to indicate an improper hip turn motion.

12. The training apparatus of claim 11 wherein said portable electronic device is secured to the user's waist.

13. The training apparatus of claim 1 wherein said mode of operation includes an exercise mode for measuring an exercise motion and providing feedback to the user, wherein said microprocessor receives X-axis, Y-axis and Z-axis values from said motion sensor and calculates a starting position and a finishing position, wherein a repetition count is incremented each time said starting position is followed by said finishing position.

14. The training apparatus of claim 13 wherein said mode of operation is selected from the group consisting of sit up mode, push up mode, bicep curl mode, lunge mode, triceps curl mode and leg lift mode.

15. The training apparatus of claim 13 wherein if said starting position is not followed by said finishing position within a predetermined time period, said microprocessor activates said output with an encouragement sound.

16. The training apparatus of claim 13 wherein said portable electronic device is secured to the user's shoulder.

17. The training apparatus of claim 1 wherein said portable electronic device output is an audio output.

18. The training apparatus of claim 1 wherein said portable electronic device output is a tactile output.

19. The training apparatus of claim 1 wherein said motion sensor is an accelerometer.

20. The training apparatus of claim 1 wherein said motion sensor is a gyroscope.

21. A training apparatus worn by a user comprising:
a portable electronic device having a microprocessor, an motion sensor, a touch screen display for receiving user input and providing visual output, and an audio output,
said motion sensor having a predetermined X-axis, Y-axis and Z-axis orientation, and responsive to movement of said portable electronic device to output X-axis, Y-axis and Z-axis values indicative of movement of said portable electronic device in said X-axis, Y-axis and/or Z-axis, and
a mode of operation selected by the user using said touch screen display and executed by said microprocessor wherein said microprocessor is responsive to said motion sensor output to provide feedback to the user corresponding to said mode of operation and said movement.

22. The training device of claim 21 wherein said mode of operation is selected from the group consisting of putter mode, head mode, shoulder mode, hip turn mode, sit up mode, push up mode, bicep curl mode, lunge mode, triceps curl mode and leg lift mode.

23. The training apparatus of claim 21 wherein said mode of operation includes a putter mode for measuring a golf putting motion and providing feedback to the user, wherein said microprocessor calculates acceleration of the portable electronic device from said X-axis value output by said motion sensor, if said measured X-axis value is greater than a lower boundary X value then said microprocessor activates said audio output to indicate a proper putting motion, if said measured X-axis value is less than a lower boundary X value, said microprocessor activates said output to indicate an improper putting motion.

24. The training apparatus of claim 23 wherein said portable electronic device is secured to the user's forearm.

25. The training apparatus of claim 21 wherein said mode of operation includes a shoulder mode for measuring a golf club swing motion and providing feedback to the user, wherein said microprocessor calculates acceleration of the portable electronic device from said X-axis, Y-axis and Z-axis values to measure a swing motion of the user's shoulders, if said Y-axis value is greater than said Z-axis value, then a sixty degree turn has been measured then said microprocessor activates said output to indicate a proper swing motion, if said Y-axis value is less than or equal to said Z-axis value, then less than a sixty degree turn has been measured, and said microprocessor activates said output to indicate an improper swing motion.

26. The training apparatus of claim 25 wherein said portable electronic device is secured to the user's shoulder.

27. The training apparatus of claim 21 wherein said mode of operation includes a shoulder mode for measuring a golf club swing motion and providing feedback to the user, wherein said microprocessor calculates acceleration of the portable electronic device from said X-axis, Y-axis and Z-axis values to measure a swing motion of the user's shoulders, if the difference of said X-axis minus said Y-axis value is less than or equal to a constant then a ninety degree turn has been measured then said microprocessor activates said output to indicate a proper swing motion, if the difference of said X-axis minus said Y-axis value is less greater than a constant then less than a ninety degree turn has been measured then said microprocessor activates said output to indicate an improper swing motion.

28. The training apparatus of claim 27 wherein said portable electronic device is secured to the user's shoulder.

29. The training apparatus of claim 21 wherein said mode of operation includes a head motion mode for measuring the user's head motion during a swing motion and providing feedback to the user, wherein said microprocessor calculates acceleration of the portable electronic device from said X-axis, Y-axis and Z-axis values to measure a swing motion of the user's head, if said Y-axis value is greater than said Z-axis value, then a sixty degree turn has been measured then said microprocessor activates said output to indicate a proper swing motion, if said Y-axis value is less than or equal to said Z-axis value, then less than a sixty degree turn has been measured, and said microprocessor activates said output to indicate an improper swing motion.

30. The training apparatus of claim 29 wherein said portable electronic device is secured to the user's head.

31. The training apparatus of claim 21 wherein said mode of operation includes a hip turn mode for measuring the user's hip turn during a swing motion and providing feedback to the user, wherein said microprocessor calculates angular rotation rate of the portable electronic device from said X-axis. Y-axis and Z-axis values to determine a yaw value to measure a hip turn motion of the user's hips, if said yaw value is greater than a predetermined yaw range value measured within a predetermined yaw time period, then a proper hip turn been measured and said microprocessor activates said output to indicate a proper hip turn motion, if said yaw value is less than or equal to said predetermined yaw range value and said predetermined yaw time period has expired, then said microprocessor activates said output to indicate an improper hip turn motion.

32. The training apparatus of claim 31 wherein said portable electronic device is secured to the user's waist.

33. The training apparatus of claim 21 wherein said mode of operation includes an exercise mode for measuring an exercise motion and providing feedback to the user, wherein said microprocessor receives X-axis, Y-axis and Z-axis values from said motion sensor and calculates a starting position and a finishing position, wherein a repetition count is incremented each time said starting position is followed by said finishing position.

34. The training apparatus of claim 21 wherein said motion sensor is an accelerometer.

35. The training apparatus of claim 21 wherein said motion sensor is a gyroscope.
